(19) United States
(12) Patent Application Publication
(10) Pub. No.: US 2024/0393540 A1
(43) Pub. Date: Nov. 28, 2024

(54) OPTICAL CONNECTION MODULE

(71) Applicant: NIPPON TELEGRAPH AND TELEPHONE CORPORATION, Tokyo (JP)

(72) Inventors: Tatsuya FUJIMOTO, Musashino-shi, Tokyo (JP); Yoshiteru ABE, Musashino-shi, Tokyo (JP); Ryo KOYAMA, Musashino-shi, Tokyo (JP); Kazuhide NAKAE, Musashino-shi, Tokyo (JP); Hiroshi WATANABE, Musashino-shi, Tokyo (JP); Chisato FUKAI, Musashino-shi, Tokyo (JP); Tomohiro KAWANO, Musashino-shi, Tokyo (JP); Kazunori KATAYAMA, Musashino-shi, Tokyo (JP)

(73) Assignee: NIPPON TELEGRAPH TELEPHONE CORPORATION, Tokyo (JP)

(21) Appl. No.: 18/701,661

(22) PCT Filed: Oct. 21, 2021
(86) PCT No.: PCT/JP2021/038968

§ 371 Date: Apr. 16, 2024

(51) Int. Cl. G02B 6/35; G02B 6/38; G02B 6/40

(52) U.S. Cl. CPC G02B 6/3546; G02B 6/3548; G02B 6/3885; G02B 6/403

(57) ABSTRACT

An object of this disclosure is to enable space saving of an optical fiber connection unit such as an optical switch.

According to this disclosure, there is provided an optical connection module that connects first and second multi-fiber connectors, in which the first and second multi-fiber connectors have optical fibers which are two-dimensionally arranged. In the first multi-fiber connector, optical fibers connected to a same optical switch are arranged in a vertical direction, and optical fibers connected to different optical switches are arranged in parallel in a horizontal direction. In the second multi-fiber connector, optical fibers connected to a same optical switch are arranged in a horizontal direction, and optical fibers connected to different optical switches are arranged in parallel in a vertical direction.

### TECHNICAL FIELD

This disclosure relates to an optical connection module.

### BACKGROUND ART

For an all-optical switch that performs path switching while keeping light as it is, various systems have been suggested as disclosed in Non Patent Literature 1, for example. Among these systems, an optical-fiber-type mechanical optical switch that controls abutment between optical fibers or optical connectors with a robot arm, a motor, or the like is inferior to the other systems in that the switching speed is low, but has many aspects at which the mechanical optical switch is superior to the other systems in terms of low loss, low wavelength dependence, multi-port properties, and a self-holding function of holding the switching state at a time when the power supply is stopped. Representative examples of such structures include a system in which a stage using an optical fiber V-shaped groove is moved in parallel, a system in which a mirror or a prism is moved in parallel or is made to change its angle so as to selectively couple an incident optical fiber with a plurality of exit optical fibers, and a system in which a jumper cable having an optical connector is connected using a robot arm.

However, the above-described conventional technology disclosed in Non Patent Literature 1 has a problem in that it is difficult to further lower electric power consumption, reduce size, and lower costs. Specifically, in the above-mentioned system in which a stage having an optical fiber V-shaped groove or a prism is moved in parallel, a motor is normally used as a drive source. However, since the mechanism linearly moves a heavy object such as a stage, a torque of a certain level or higher is required for the motor, and electric power consumption for obtaining the appropriate output is required to maintain the necessary torque. Since optical axis alignment using a single-mode optical fiber requires an accuracy of about 1 μm or less, it is necessary to convert rotational motion of the motor into linear motion in a sub-μm-step in a mechanism (a ball screw is generally used). An optical fiber pitch of an optical fiber array on the output side, which is usually used, is equivalent to about 125 μm of a cladding outer diameter of the optical fiber or about 250 μm in a coating outer diameter of the optical fiber. When an increased number of optical fibers is installed while maintaining the optical fiber pitch, the optical fiber array on the output side becomes large. As a result, problems arise in that the distance of linear motion becomes longer, the actual drive time of the motor has to be made longer, and the electric power consumption becomes higher. Therefore, such an optical-fiber-type mechanical optical switch normally requires electric power of several hundreds of mW or more. Meanwhile, the robot arm system using an optical connector has a problem in that a large amount of electric power, like several tens of watts or more, is required for the robot arm that controls insertion and removal of the optical connector or a ferrule. In an environment where only an optical fiber is provided, such as an outdoor overhead optical connection point, it is difficult to secure sufficient electric power to drive these optical switches.

FIG. 1 is a schematic diagram of a 4×8 optical switch realized by combining eight 1×4 optical switches and four 1×8 optical switches. In order to configure a 4×8 optical switch, it is necessary to connect all of the 1×8 optical switches for each 1×4 optical switch, and a portion where this connection is made is an optical shuffle connection portion in FIG. 1. An N×M optical switch needs to have N×M optical connections at the optical shuffle connection portion, and in the case of the 4×8 optical switch in FIG. 1, 32 optical connections are required.

FIG. 2 is a diagram for realizing a conventional optical shuffle connection of the 4×8 optical switch. Since 32 fusion splices are made for the optical shuffle connection, 32 fusion sleeves are required.

### CITATION LIST

### Non Patent Literature

Non Patent Literature 1: M. Ctepanovsky, “A Comparative Review of MEMS-Based Optical Cross-Connects for All-Optical Networks From the Past to the Present Day,” IEEE Communications Surveys & Tutorials, Vol. 21, No. 3, pp. 2928-2946, 2019.
Non Patent Literature 2: Katsuki Suematsu et al., “Super Low-Loss/Super High-Density Multi-fiber Optical Connector”, Furukawa Electric Review, No. 111, pp. 50-55, January 2003 (https://www.furukawa.co.jp/jiho/fjlll/fj111_11.pdf)

### SUMMARY OF INVENTION

### Technical Problem

As in an example illustrated in FIG. 2, an N×M optical switch needs to have N×M optical connections, and the optical switch needs to have N×M fusion sleeves as a whole. The optical switch is configured of multiple fusion sleeves, thereby, becoming large in size.

In this respect, an object of this disclosure is to enable space saving of an optical fiber connection unit such as an optical switch.

### Solution to Problem

There is provided an optical connection module according to this disclosure that connects first and second multi-fiber connectors,
in which the first and second multi-fiber connectors have optical fibers which are two-dimensionally arranged.

In the first multi-fiber connector, optical fibers connected to the same optical switch are arranged in a vertical direction, and optical fibers connected to different optical switches are arranged in a horizontal direction.

In the second multi-fiber connector, optical fibers connected to the same optical switch are arranged in a horizontal direction, and optical fibers connected to different optical switches are arranged in a vertical direction.

### Advantageous Effects of Invention

According to this disclosure, it is possible to save a space for an optical fiber connection unit such as an optical switch.

### BRIEF DESCRIPTION OF DRAWINGS

FIG. 1 is a schematic diagram of a 4×8 optical switch realized by combining eight 1×4 optical switches and four 1×8 optical switches.

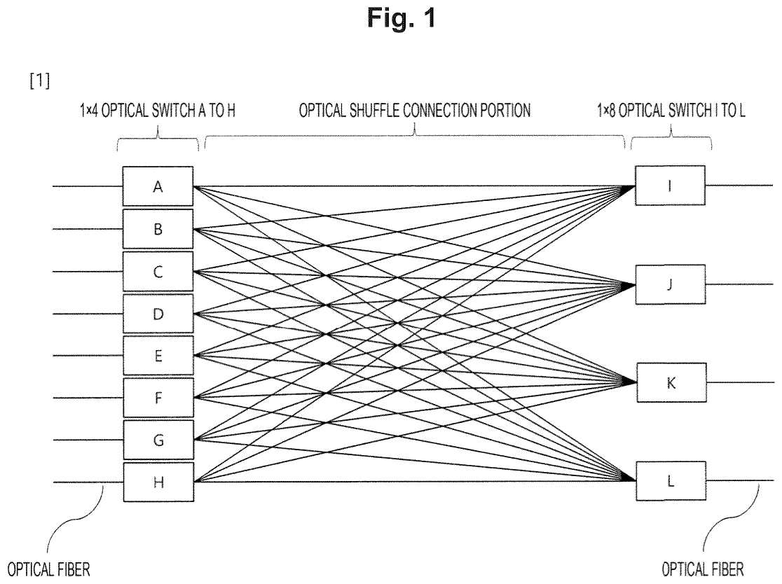

FIG. 2 is a diagram for explaining a problem in the optical switch of FIG. 1.

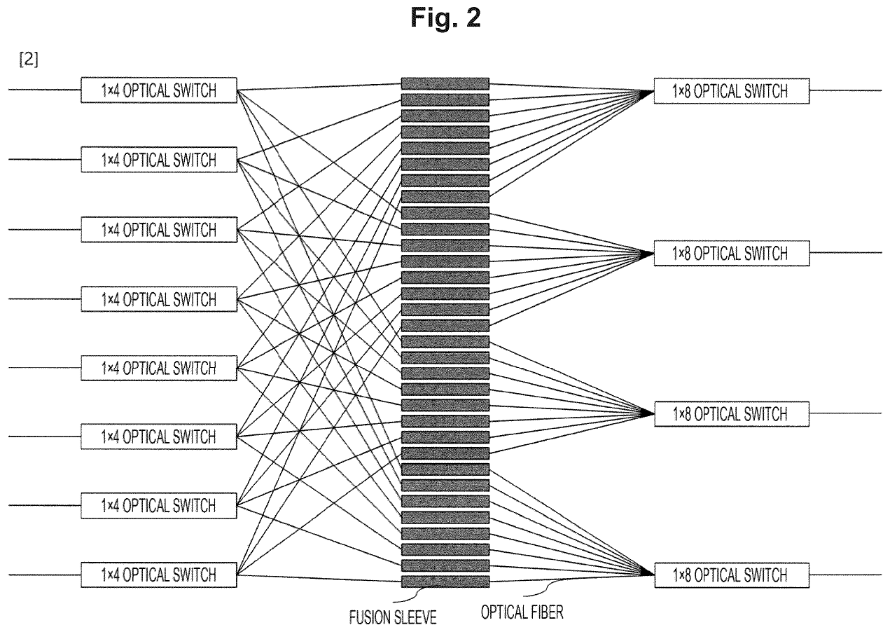

FIG. 3 is a configuration example of an optical connection module according to an embodiment of this disclosure.

FIG. 4 is an enlarged view of multi-fiber optical connectors CA and CB.

FIG. 5 is a configuration example of the optical connection module according to the embodiment of this disclosure.

FIG. 6 is a configuration example of a two-dimensional array MT connector.

FIG. 7 is a configuration example of the two-dimensional array MT connector.

FIG. 8 is a configuration example of the two-dimensional array MT connector of this disclosure.

### DESCRIPTION OF EMBODIMENTS

Hereinafter, embodiments of this disclosure will be described in detail with reference to the drawings. Further, this disclosure is not limited to the embodiments to be described below. These embodiments are merely examples, and this disclosure can be carried out in forms with various modifications and improvements based on the knowledge of those skilled in the art. Further, configurational components having the same reference signs in this specification and the drawings denote the same configurational components.

An optical connection module according to this disclosure connects first and second multi-fiber connectors
in which optical fibers can be two-dimensionally arranged.

In the first multi-fiber connector, optical fibers connected to the same optical switch are arranged in a vertical direction, and optical fibers connected to different optical switches are arranged in a horizontal direction.

In the second multi-fiber connector, optical fibers connected to the same optical switch are arranged in a horizontal direction, and optical fibers connected to different optical switches are arranged in a vertical direction.

According to this disclosure, such configurations enable collective optical shuffle connection using a multi-fiber connector. Hereinafter, an example in which the first and second multi-fiber connectors are N×M-fiber (N and M are natural numbers of 2 or more) connectors will be described.

### First Embodiment

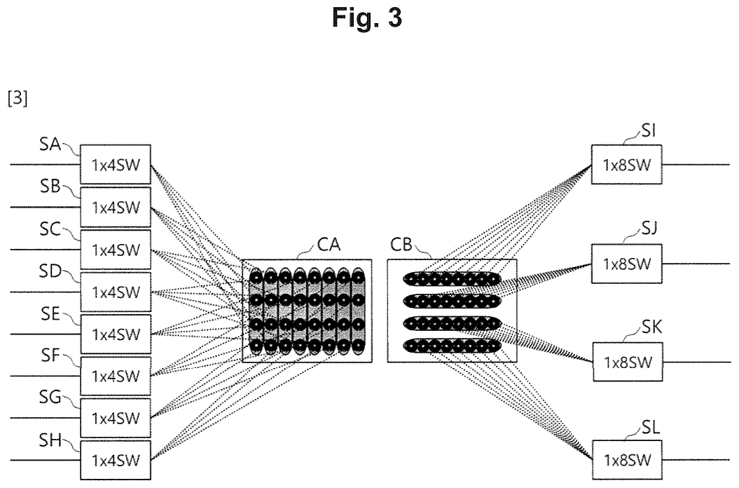

FIG. 3 is a configuration example of an optical connection module that connects a 4×8 multi-fiber connector. A multi-fiber optical connector CA is manufactured by arranging four optical fibers FA from each of the 1×4 optical switches SA to SH vertically in order to form a multi-fiber optical connector. In addition, a multi-fiber optical connector CB is manufactured by arranging eight optical fibers FB from each of the 1×8 optical switches SI to SL vertically in order to form a multi-fiber optical connector.

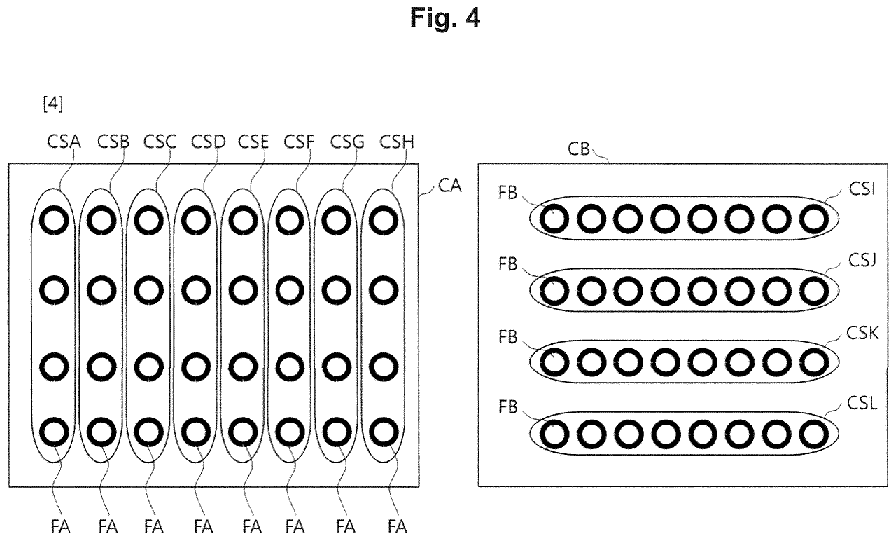

FIG. 4 is an enlarged view of the multi-fiber optical connectors CA and CB. In the multi-fiber optical connector CA, four-fiber optical connectors CSA to CSH are arranged in parallel in the horizontal direction. As a result, the optical fibers FA of the multi-fiber optical connector CA are arranged in four rows and eight columns. In the multi-fiber optical connector CB, eight-fiber optical connectors CSI to CSL are arranged in parallel in the vertical direction. As a result, the optical fibers FB of the multi-fiber optical connector CB are arranged in four rows and eight columns. By connecting the multi-fiber optical connector CA and the multi-fiber optical connector CB manufactured as described above, optical shuffle connection is realized by one multi-fiber optical connector.

A fiber tape in which four optical fibers are one-dimensionally arranged may be used as the optical connectors CSA to CSH, and a fiber tape in which eight optical fibers are one-dimensionally arranged may be used as the optical connectors CSI to CSL. Further, this disclosure is not limited thereto, and an eight-fiber tape may be configured by arranging two fiber tapes in series in which four optical fibers are one-dimensionally arranged. In addition, a fiber tape in which optical fibers are two-dimensionally arranged may be used.

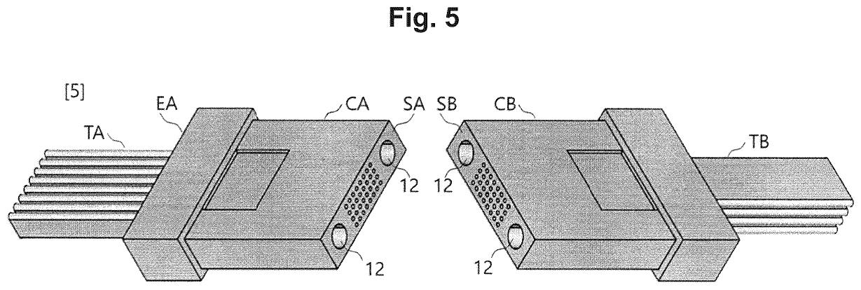

In this case, as the multi-fiber optical connectors CA and CB, MT optical connectors arranged two-dimensionally as illustrated in FIG. 5 may be used, or a push-pull MPO connector to which a housing is attached may be used. Similarly to an existing two-dimensional MT ferrule (Non Patent Literature 2), the multi-fiber optical connector CB (horizontally-arrayed two-dimensional array MT connector) in FIG. 5 is manufactured by inserting M N-fiber optical tapes TB into an MT ferrule (not illustrated) to be parallel to a longitudinal direction of the MT ferrule. On the other hand, a multi-fiber optical connector CA (vertically-arrayed two-dimensional array MT connector) is manufactured by inserting N M-fiber optical tapes TA into an MT ferrule (not illustrated) to be perpendicular to a longitudinal direction of the MT ferrule. Further, the longitudinal direction of the MT ferrule may be a direction parallel to a straight line continuous from a guide pin hole 12.

### Second Embodiment

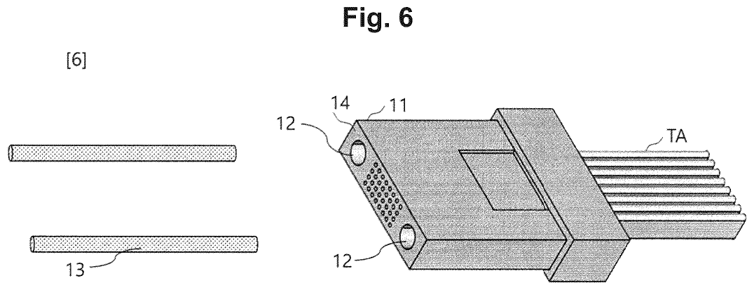

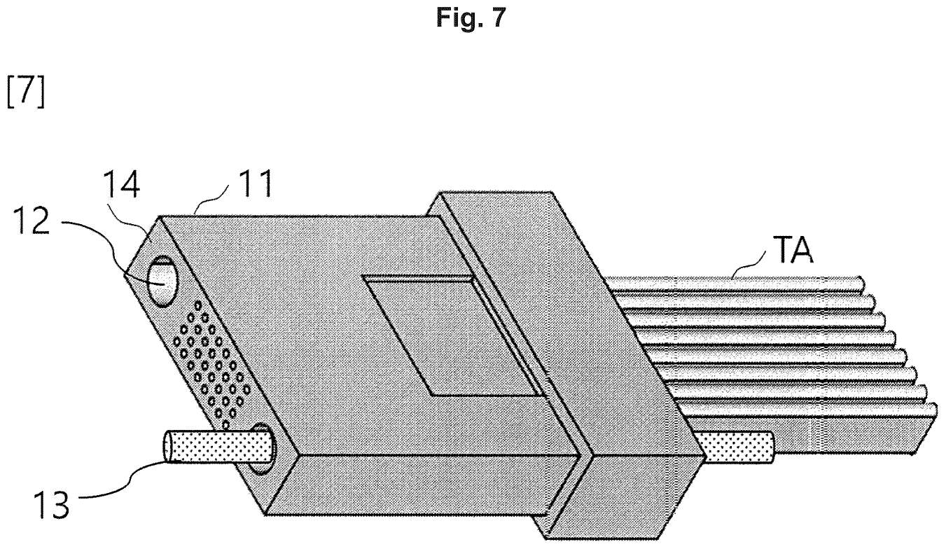

In a case where the guide pin hole 12 penetrates a two-dimensional array MT connector 11, as illustrated in FIGS. 6 and 7, a guide pin 13 can penetrate the connector to a side opposite to a connector end surface 14, when the guide pin 13 passes through the guide pin hole 12. In this case, in the vertically-arrayed two-dimensional array MT connector 11, the fiber tape TA to be inserted into the connector may be bent toward the guide pin hole 12 side, and the guide pin 13 may cause a scratch or the like on the fiber tape TA.

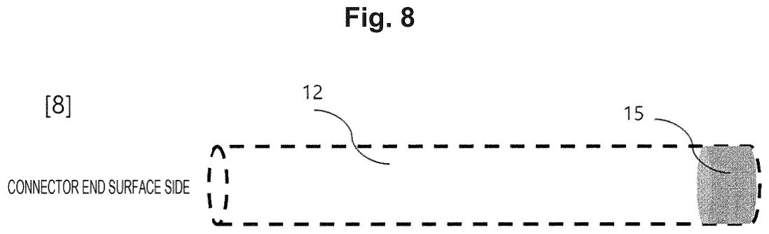

Therefore, as illustrated in FIG. 8, the multi-fiber optical connector CA according to the embodiment has a structure in which a penetration preventing portion 15 blocks the guide pin hole on the side opposite to the connector end surface SA of the guide pin hole 12 (the side of the reference sign EA illustrated in FIG. 5). However, in order not to prevent attachment of an MT clip in the multi-fiber optical connector CA, the penetration preventing portion 15 is disposed in the guide pin hole 12 so as not to protrude from the MT connector. In addition, a thickness of the penetration preventing portion 15 needs to be a thickness that prevents the guide pin 13 from protruding from the guide pin hole 12 of the MT connector on the opposing side when the MT connector is connected, and is set to be within about 3 mm.

Further, the penetration preventing portion 15 is not limited to being provided in the multi-fiber optical connector CA and may be provided in the guide pin hole 12 of the multi-fiber optical connector CB.

### Effects Produced by this Disclosure

In a case where it is necessary to perform an optical shuffle connection such as manufacturing an optical switch having any number of fibers by combining a plurality of 1×N optical switches, it is possible to realize space saving of the connection portion by connecting the horizontally-arranged two-dimensional array connectors CB and the vertically-arranged two-dimensional array connectors CA.

### Points of Present Disclosure

As described above, in this disclosure, a multi-fiber connector in which a plurality of 1×N optical switches are combined and the 1×N optical switches are two-dimensionally arranged horizontally and a multi-fiber connector in which the 1×N optical switches are two-dimensionally arranged vertically are connected by connectors. Accordingly, this disclosure realizes optical shuffle connection.

Any method of realizing the multi-fiber connector can be employed, for example, a full-mesh optical connection can be realized compactly by optically connecting a group of horizontally aligned fiber optic tapes (optical fibers arranged in an array) and a group of vertically aligned fiber optic tapes (optical fibers arranged in an array).

In this case, a vertically-arrayed two-dimensional array MT ferrule produced by inserting a tape core wire so as to be perpendicular to the longitudinal direction of the MT ferrule may be realized. The MT connector using the MT ferrule may have a structure in which the guide pin does not penetrate toward a tape core side.

### INDUSTRIAL APPLICABILITY

This disclosure can be applied to information and communication industries.

### REFERENCE SIGNS LIST

11 MT connector
12 Guide pin hole
13 Guide pin
14 Connector end surface
15 Penetration preventing portion
16 Connector end surface side

1. An optical connection module that connects first and second multi-fiber connectors,
wherein the first and second multi-fiber connectors have optical fibers which are two-dimensionally arranged,
in the first multi-fiber connector, optical fibers connected to a same optical switch are arranged in a vertical direction, and optical fibers connected to different optical switches are arranged in a horizontal direction, and
in the second multi-fiber connector, optical fibers connected to a same optical switch are arranged in a horizontal direction, and optical fibers connected to different optical switches are arranged in a vertical direction.

2. The optical connection module according to claim 1,
wherein the first and second multi-fiber connectors are N×M-fiber connectors,
the first multi-fiber connector is connected to M optical switches which are connectable by N optical fibers, and
the second multi-fiber connector is connected to N optical switches which are connectable by M optical fibers.

3. The optical connection module according to claim 2,
wherein the first multi-fiber connector has M N-fiber optic tapes arranged in parallel, each of the M N-fiber optic tapes having N optical fibers which are one-dimensionally arranged,
the N-fiber optic tape is connected to M 1×N optical switches,
the second multi-fiber connector has N M-fiber optic tapes arranged in parallel, each of the N M-fiber optic tapes having M optical fibers which are one-dimensionally arranged, and
the M-fiber optic tape is connected to N 1×M optical switches.

4. The optical connection module according to claim 3,
wherein the first multi-fiber connector has a penetration preventing portion in a guide pin hole into which a guide pin is inserted, the penetration preventing portion preventing the guide pin from coming into contact with the N-fiber optic tape.
